(19) United States
(12) Patent Application Publication
(10) Pub. No.: US 2018/0222547 A1
(43) Pub. Date: Aug. 9, 2018

(54) BIKE PEDAL

(71) Applicants: Luc Yves Polspoel, Brasschaat (BE); Ronald Polspoel, Brasschaat (BE)

(72) Inventors: Luc Yves Polspoel, Brasschaat (BE); Ronald Polspoel, Brasschaat (BE)

(21) Appl. No.: 15/748,155

(22) PCT Filed: Jul. 31, 2015
(86) PCT No.: PCT/EP2015/067718

§ 371 Date: Jan. 26, 2018

(51) Int. Cl. B62M 3/08

(52) U.S. Cl. CPC B62M 3/08

(57) ABSTRACT

A bike pedal comprising a pedal shaft arranged for being connected at one end to the main body of the bike; and a pedal body arranged for defining a supporting surface for the foot of a person, the pedal body comprising a pedal shaft sleeve arranged for receiving the pedal shaft. The pedal body comprises means for securing at least one plate member provided with at least one opening arranged for allowing dirt and water to be channeled away from the pedal body, wherein the at least one opening of the at least one plate member is shaped according to a graphic design feature.

### TECHNICAL FIELD

The present invention relates to a bike pedal and more specifically to a bike pedal arranged for receiving at least one plate member having at least one opening that is shaped according to a graphic design.

### BACKGROUND ART

Pedaled vehicles, such as bicycles, have been around for more than a century and they still remain very popular as a recreational form of transportation. Bicycle riders generally prefer to customise their bikes in order to improve their aesthetics by customising certain aspects of the pedaled vehicle. For example, one way for customising the pedaled vehicle is by providing the pedals with plate members having a graphical design, such as a name, a logo, etc.

U.S. Pat. No. 8,381,616 discloses a pedal that includes a pedal body configured for engaging the foot of the cyclist and defining a first major side and a second major side of the pedal. The pedal is provided on each of the first and second major sides with a plate member that includes a graphic design feature. However, the pedal of U.S. Pat. No. 8,381,616 has the disadvantage that the plate member does not have any means for channeling water and dirt away from the pedal. As a result, under these conditions, the pedal would become slippery thereby compromising the safety of the cyclist.

### DISCLOSURE OF THE INVENTION

It is an aim of the present invention to provide a pedal that can be provided with a graphical design feature that overcomes the disadvantages of the prior art.

This aim is achieved according to the invention with the showing the technical characteristics of the characterising part of the first claim.

More specifically according to embodiments of the present invention a bike pedal is provided. The bike pedal comprises a pedal shaft arranged for being connected at one end to the main body of the bike and a pedal body arranged for defining a supporting surface for the foot of a person. The pedal body comprises a pedal shaft sleeve arranged for receiving the pedal shaft. According to the present invention the pedal body comprises means for securing at least one plate member provided with at least one opening arranged for allowing dirt and water to be channeled away from the pedal body, wherein the at least one opening of the at least one plate member is shaped according to a graphic design feature.

It has been found that by providing the at least one plate member with an opening that is shaped according to a graphic design, the bike pedal can be customised according to the needs of the cyclists while ensuring that the safety of the cyclist is not compromised. The openings in the plate member are arranged to channel away from the pedal surface water and/or dirt accumulated under specific weather conditions, such as rain, snow, etc. As a result, by channeling away the water and dirt accumulated under these weather conditions the grip of the pedal surface is significantly improved, thereby ensuring that the foot of the cyclists is maintained in engagement with the pedal under these weather conditions.

According to embodiments of the present invention, the plate member can be provided, for example by printing or other methods, with further ornaments such as colours, graphical features, etc. These further ornaments can be provided on a single side of the plate member or both sides of the plate member. If only a single side of the plate member is provided to contact the foot of the cyclist, preferably that side is provided with the further ornaments. Further ornaments being provided on a side facing away from the side contacting the foot of the cyclist, may for example be visible through openings in the pedal body, for example through openings present in another plate member.

According to embodiments of the present invention, the means for securing are arranged for releasably securing the at least one plate member on the pedal body. As a result, the plate member can be replaced with another plate member having at least one opening that is shaped according to different graphic design feature. Therefore, the cyclist can easily customise the bicycle pedals by replacing the plate member with another plate member having a different design feature. Moreover the cyclists instead of replacing the at least one plate member, also referred to as the at least first plate member, may consider adding a further plate member on the pedal body, also referred to as at least a second plate member, which second plate member may be provided with at least one opening shaped according to the a design feature that may be the same or different from the design feature of the at least one first plate member.

According to embodiments of the present invention, the supporting surface of the pedal body comprises a first side and a second side, which are spaced apart from each other and supported by supporting means positioned in between. The supporting surface of the pedal body is provided with at least one opening extending between the first and the second sides. The at least one pedal body opening is at least partially aligned with the at least one plate member opening. In this way, the water and/or dirt accumulated on the pedal supporting surface can be efficiently channeled away, thereby ensuring that the safety of the cyclist is not compromised.

According to embodiments of the present invention, each of the first and second side of the pedal body is configured for receiving at least one plate member. In this way, the at least one plate member can be easily replaced with another plate member of an additional plate member can be added to the pedal body. The at least one plate member may also be arranged for being secured in the space formed between the first and second sides. Furthermore, the at least one plate member is arranged for being secured directly on the pedal shaft sleeve, wherein the at least one plate member defines the supporting surface of the pedal body.

According to embodiments of the present invention, the securing means arranged for securing the plate member may comprise a guide, which may be arranged for receiving the at least one plate member in a sliding manner. In this way, the plate can be easily replaced without the need for special tools. Furthermore, the at least one plate member may be secured on the guide by means of a snap fit connection.

According to embodiments of the present invention, the means for securing the at least one plate member may comprise a set of screws arranged for cooperating with corresponding bores provided on the pedal body. In this way, the at least one plate member may be better secured on the pedal body while allowing for the at least one plate to be easily replaced.

According to embodiments of the present invention, the surface of the at least one plate member may be provided with anti-slippery means. The anti-slippery means are arranged for increasing the grip of the pedal body, thus preventing the foot of the cyclist from slipping under bad weather conditions, such as rain, snow, etc. For example, the at least one plate member may be provided with anti-slippery means comprising a plurality of protrusion protruding from the surface of the at least one plate member. Furthermore, the at least one plate member may be provided with anti-slippery means comprising a plurality of indentations provided on the surface of the at least one plate member. Moreover, the at least one plate member may be provided with anti-slippery means comprising an anti-slippery material arranged for being attached to the surface of the at least one plate member.

### BRIEF DESCRIPTION OF THE DRAWINGS

The invention will be further elucidated by means of the following description and the appended figures.

FIG. 1 shows an example of the pedal body according to embodiments of the present invention.

FIG. 2 shows an example of a bike pedal according to embodiments of the present invention.

FIG. 3 shows an example of a bike pedal comprising two plate members on each of the first and second sides according to embodiments of the present invention.

FIGS. 4 and 5 shows different views of an example of a bike pedal according to embodiments of the present invention having at least one plate member positioned in the space between the first and second sides of the pedal body.

FIG. 6 shows an example of a bike pedal according to embodiments of the present invention, wherein the plate members are positioned directly on the pedal shaft.

FIG. 7 shows an example of a bike pedal with a further example of a pedal body according to the present invention,

### MODES FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

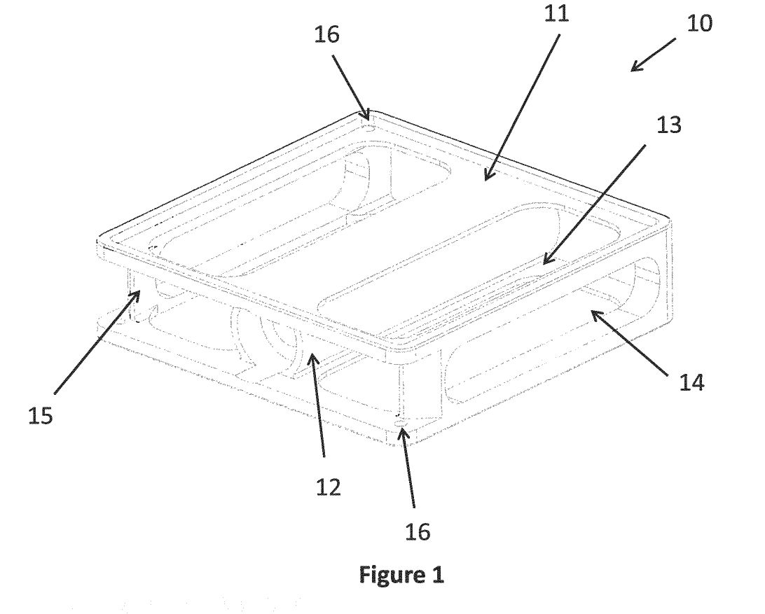

The present invention will be elucidated by means of the example embodiments shown in FIGS. 1 to 6, which will be described in more details below.

FIG. 1 shows an example of a pedal body 10 according to embodiments of the present invention. The pedal body 10 may be arranged for defining a supporting surface 11 for the foot of a person, and may comprise a pedal shaft sleeve 12 arranged for receiving a pedal shaft 21. The supporting surface of the pedal body 10 may be provided with a first side and a second side, which may be positioned opposite one another. The first and second sides may be spaced apart from each other and supported by supporting means 15 positioned in between. The supporting surface of the pedal body 10 may be provided with at least one opening 13, which may extend between the first and the second sides. The pedal body 10 may be further provided with openings 14 provided between the supporting means 15. The pedal body 10 may be provided with securing means 16 comprising a set of screws arranged for cooperating with corresponding bores provided on the pedal body 10.

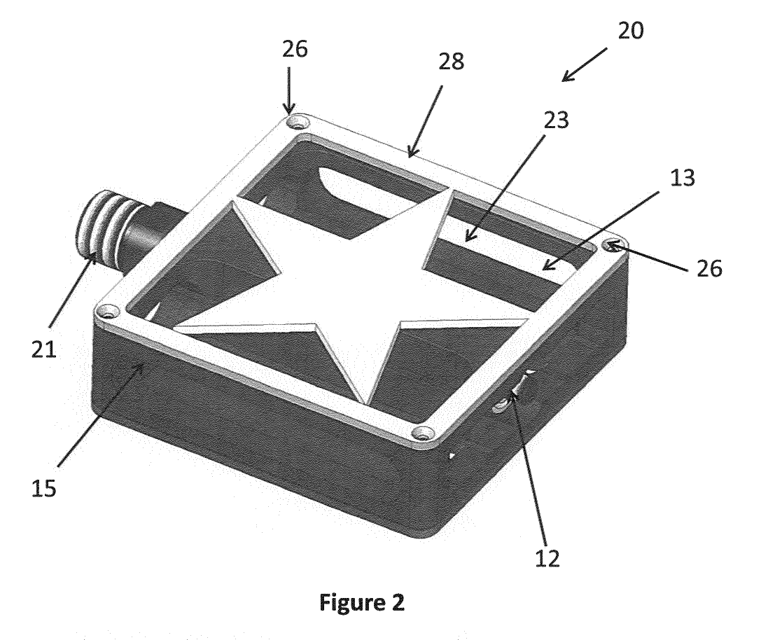

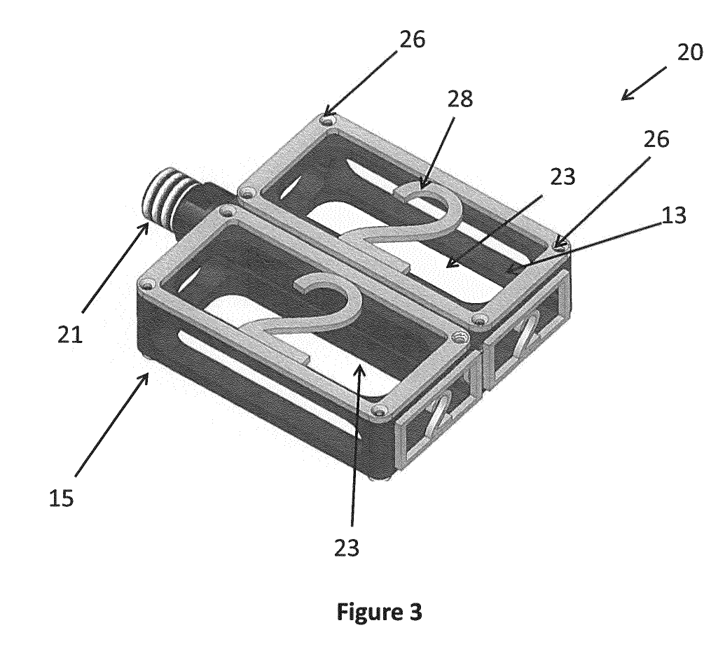

FIG. 2 shows a bike pedal 20 according to embodiments of the present invention. The bike pedal 20 may comprise a pedal shaft 21 arranged for being inserted in the pedal shaft sleeve 12 of the pedal body 10, shown in FIG. 1. The bike pedal 20 is provided with at least one plate member 28, which is secured by the securing means 26 on each of the first and second sides of the pedal body supporting surface 11. The plate member 28, once secured on the supporting surface 11 of the pedal body 10 is arranged for engaging the body of the cyclist, thereby defining the pedal surface on which the body of the cyclist is supported. The plate member 28 may comprises at least one opening 23, which is shaped according to a graphic design feature, e.g. a star. Naturally, other graphic design features can be used such as for example any one or more of the following: letters of the alphabet, numerals, emoticons, etc. The at least one plate member opening 23 is arranged to be at least partially aligned with the pedal body openings 13 so that water and/or dirt accumulated on the pedal surface can be channeled away from the pedal body. As a result, the grip of the pedal surface is significantly improved, thereby ensuring that the body of the cyclist is maintained in engagement with the pedal under bad weather conditions, such as rain, snow, etc. The at least one plate member 28 may be secured on the first and second sides of the pedal body supporting surface 11 with securing means 26 comprising a set of screws arranged for cooperating with corresponding bores provided on the pedal body 10. The securing means 26 are arranged for releasably securing the at least one plate member 28 on the pedal body 10. As a result, the plate member 28 can be replaced with another plate member 28 having at least one opening 23 that is shaped according to different graphic design feature. Therefore, the cyclist can easily customise the bicycle pedal 20 by replacing the plate member 28 with one or more plate members 28 having a different design feature. For example, FIG. 3 shows the bike pedal 20, wherein each of the first and second sides of the supporting surface 11 is provided with two plate members 28 each having at least one opening 23, which is at least partially aligned with the pedal body openings 13. Although the plate members can be provided next to each other as shown in FIG. 3, the plate members can also be provided on top of each other such that the combination of the plate members on top of each other can provide an additional aesthetic effect. The plate members in such configuration can be provided directly on top of each other and adjacent to one another or can be provided such that an opening is present in between the plate members, according to the desired effect.

According to embodiments of the present invention, the plate member may be provided in the form of a sleeve arranged to be positioned around the pedal body. For example, the plate member may be provided in U-shape having three surfaces arranged to be secured on the pedal body by means of a securing mechanism comprising a set of screws, a snap-fit connection or a combination of a snap-fit connection and a set of screws. According to embodiments of the present invention, the plate member may be provided with four surfaces, thereby forming a hollow space, which may be arranged for receiving the pedal body. According to embodiments of the present invention, the plate member may be provided with more than four surfaces, whereby in at least one surface an opening is formed arranged for receiving the pedal body.

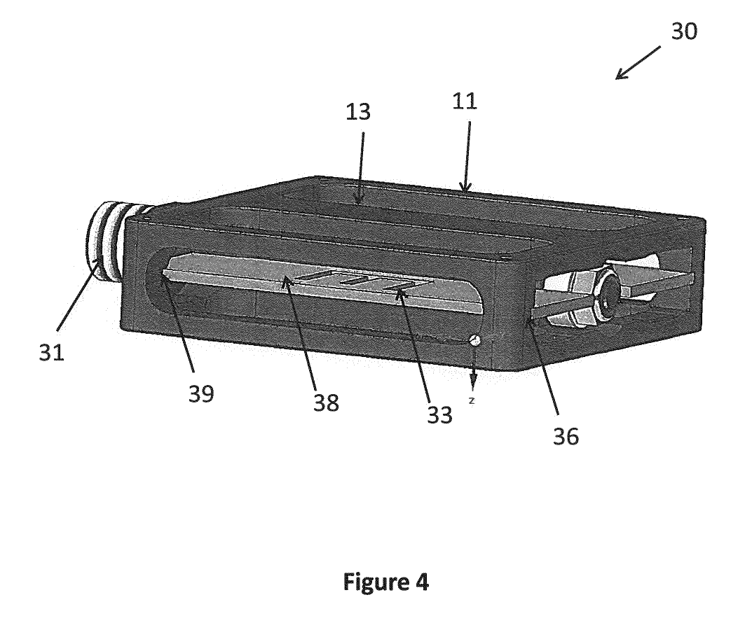

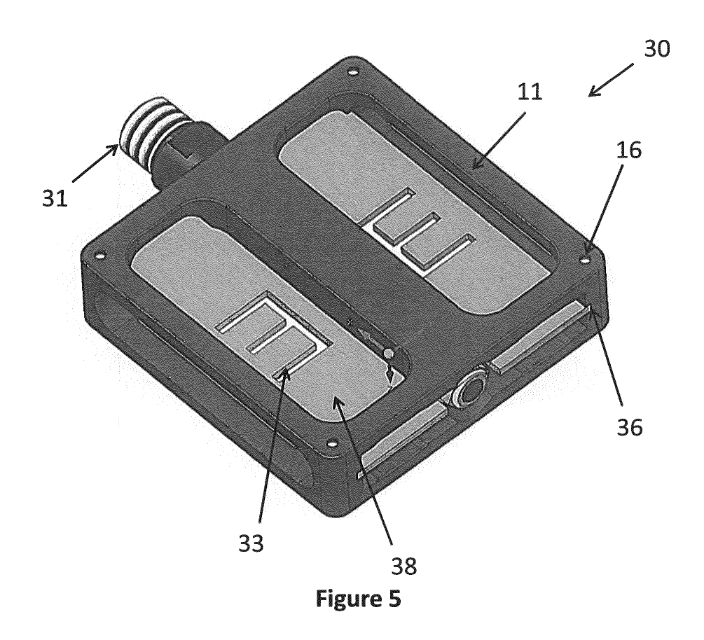

FIG. 4 shows an example of a bike pedal 30, wherein the at least one plate member 38 is provided in the space between the first and second sides of the pedal body supporting surface 11, which is defined by the pedal body supporting means 15. In this configuration, the supporting means may be provided with securing means comprising a guide 39 arranged for receiving the at least one plate member 38 in a sliding manner. FIG. 5 shows a top view of the bike pedal 30 of FIG. 4, where it is shown that the at least one plate member 38 is provided with openings 33 that are at least partially aligned with pedal body openings 13, thereby allowing dirt and/or water to be channeled away from the pedal surface.

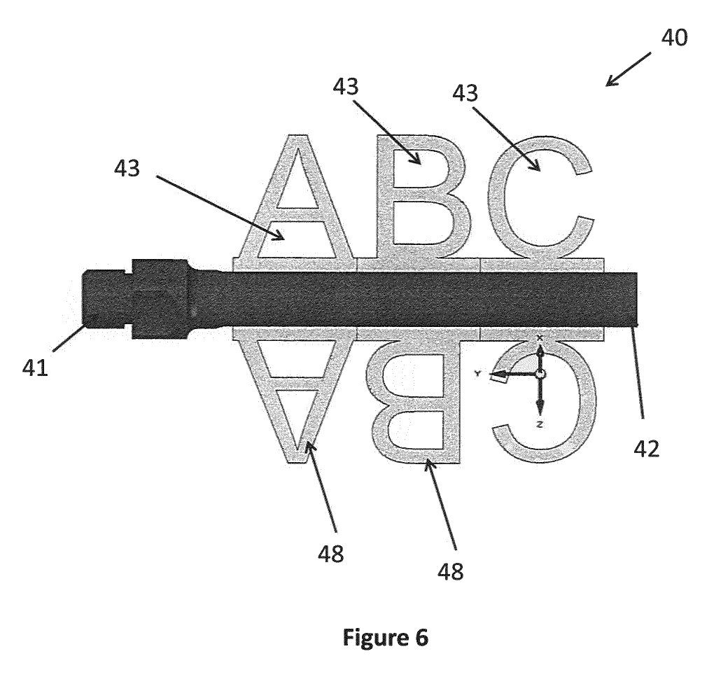

FIG. 6 shows a bike pedal 40 according to embodiments of the present invention. The bike pedal 40 comprises a pedal body comprising a shaft sleeve 42 arranged for receiving a pedal shaft 41. The pedal shaft sleeve 42 may arrange for receiving on its outer surface at least one plate member 43 having at least one opening 43 which is shaped according to a graphic design feature, e.g. letters of the alphabet and/or numerals. The at least one plate member may be secured on the pedal shaft sleeve by securing means that may comprise a guide and/or a set of screws arranged to cooperate with corresponding bores provided on the pedal shaft sleeve. In this configuration, the at least one plate member 48 may be arranged for defining the supporting surfaces of the pedal body.

According to embodiments of the present invention, and more in particular with reference to the bike pedal 40 of FIG. 6, the pedal sleeve 42 may be arranged for receiving on its outer surface at least one pedal member 43 having a continuous surface, more in particular with no openings. The at least one plate member 43 may be provided in different shapes and dimensions that may adhere to a chosen graphic design.

According to embodiments of the present invention, the plate member, which defines once positioned on the pedal body the supporting surface of the pedal surface, may be provided with anti-slippery means. The anti-slippery means are arranged for increasing the grip of the pedal body, thus preventing the foot of the cyclist from slipping under bad weather conditions, such as rain, snow, etc. For example, the at least one plate member may be provided with anti-slippery means comprising a plurality of protrusion protruding from the surface of the at least one plate member. Furthermore, the at least one plate member may be provided with anti-slippery means comprising a plurality of indentations provided on the surface of the at least one plate member. Moreover, the at least one plate member may be provided with anti-slippery means comprising an anti-slippery material arranged for being attached to the surface of the at least one plate member.

According to embodiments of the present invention, the plate member, more preferably the surface that remains visible after mounting the plate member to the pedal body, is provided with a surface structure such as for example anti-slippery means in the form of indentations made into the surface or for example or a relief, for example a bas-relief or a high-relief, sunk-relief or counter-relief, for example a letter or a number etched in the plate surface.

According to embodiments of the present invention, the openings provided on the plate member may cover at least 10 percent of the total pedal body area, at most 99 percent of the total pedal body area, preferably at most 80 percent, more preferably at most 70 percent, even more preferably at most 60 percent.

According to embodiments of the present invention, the plate member may be manufactured from plastic, a metal alloy, or any other desirable material that is suitable for use in a bike pedal. The plate member may be further formed from a transparent material, such as plastic, and the like.

According to embodiments of the present invention, the securing means 16 for securing the plate member to the pedal body may be provided by means of a snap-fit connection between the pedal body and the plate member, thereby eliminating the need for providing a set of screw arranged to cooperate with corresponding bores on the pedal body. The securing means may further be implemented by means of a combination of a snap-fit connection and a set of screws arranged to cooperate with corresponding bores provided on the pedal body so as to ensure that the plate member is securely positioned on the pedal body.

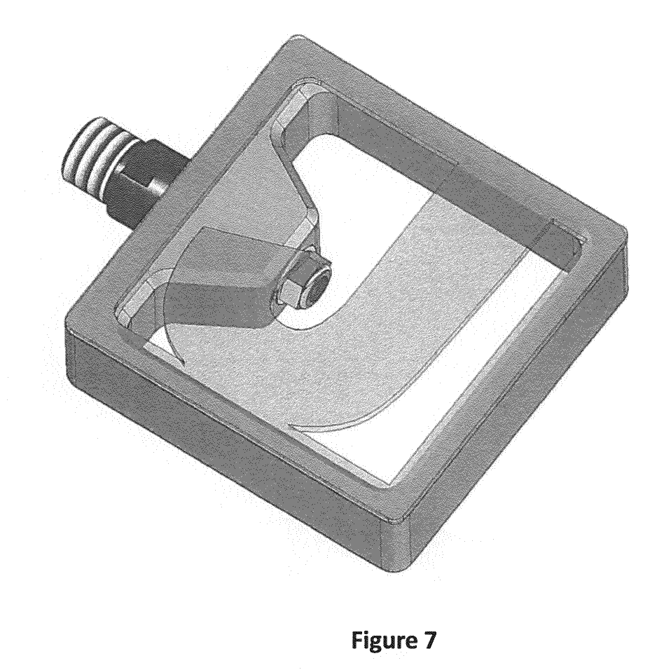

FIG. 7 shows a further example of a bike pedal according to the invention with a further pedal body according to the invention. As can be seen the shaft no longer completely crosses the pedal body, but has a more reduced length, allowing the dimensions of the hole through the body to be increased such as to increase the amount of dirt that can be transferred through the pedal body. By way of example, the letter “J” is displayed as part of the plate member. This is however not critical for the invention, as discussed above.

1. A bike pedal, comprising:
a pedal shaft configured to connect at one end to the main body of the bike; and
a pedal body including a supporting surface for the foot of a person, the pedal body comprising:
a pedal shaft sleeve configured to receive the pedal shaft;
a plate member having an opening configured to allow debris and water to be channeled away from the pedal body, wherein the opening of the plate member is shaped according to a graphic design feature; and
means for releasably securing the plate member, wherein the plate member is provided with anti-slippery means.

2. (canceled)

3. The bike pedal of claim 1, wherein the supporting surface of the pedal body comprises a first side and a second side spaced apart from each other and supported by supporting means positioned therebetween.

4. The bike pedal of claim 3, wherein the supporting surface of the pedal body includes an opening extending between the first and the second sides.

5. The bike pedal of claim 4, wherein the opening of the pedal body is at least partially aligned with the opening of the plate member.

6. The bike pedal of claim 5, wherein each of the first and second side of the pedal body is configured for receiving at least one plate member.

7. The bike pedal of claim 6, wherein the at least one plate member is configured to be secured in the space formed between the first and second sides.

8. The bike pedal of claim 1, wherein the plate member is configured to be secured directly on the pedal shaft sleeve, wherein the plate member defines the supporting surface of the pedal body.

9. The bike pedal of claim 1, wherein the means for releasably securing the plate member comprises a guide arranged for receiving the plate member in a sliding manner.

10. The bike pedal of claim 1, wherein the means for means for releasably securing the plate member comprises a set of screws for cooperating with corresponding bores provided on the pedal body.

11. (canceled)

12. The bike pedal of claim 1, wherein the anti-slippery means comprises a plurality of protrusions extending from a surface of the plate member.

13. The bike pedal of claim 1, wherein the anti-slippery means comprises a plurality of indentations provided on a surface of the plate member.

14. (canceled)

15. The bike pedal of claim 1, wherein the opening of the plate member covers between 10% and 99% of a total pedal body area.

16. The bike pedal of claim 1, wherein the opening of the plate member covers between 10% and 60% of a total pedal body area.

17. The bike pedal of claim 1, wherein the anti-slippery means comprises an anti-slippery material.
